(19) United States
(12) Patent Application Publication
(10) Pub. No.: US 2021/0276894 A1
(43) Pub. Date: Sep. 9, 2021

(54) Filter for Treating a Fluid in a Pipe, in Particular a Pipe of a Water Network, and Operating Method Thereof

(71) Applicant: R.B.M. IBOX S.R.L., Nave (BS) (IT)

(72) Inventor: Guido Bossini, Brescia (IT)

(21) Appl. No.: 16/338,896

(22) PCT Filed: Oct. 17, 2017
(86) PCT No.: PCT/IB2017/056436

§ 371 Date: Apr. 2, 2019

(30) Foreign Application Priority Data
Oct. 18, 2016 (IT) 102016000104280

(51) Int. Cl. C02F 1/48; C02F 1/00

(52) U.S. Cl. CPC C02F 1/482; C02F 2101/203; C02F 1/004; C02F 1/488

(57) ABSTRACT

A filter for treating a fluid in a piping, in particular a piping included in a water supply network, includes: a main body having at least one internal chamber and a filtering element for treating the fluid, the filtering element having at least one magnetic element housed at least partially in the chamber and adapted to intercept and trap the ferrous impurities that are present in the fluid to be treated. At least one magnetic detector is associated with the main body for detecting the magnetic field generated by the at least one magnetic element. A control unit is associated with the at least one magnetic detector, the control unit being adapted to process the magnetic field information received from the at least one magnetic detector and to provide an indication about the quantity of impurities that have accumulated on the filtering element.

### BACKGROUND OF THE INVENTION

### 1. The Field of the Invention

The present invention relates to a filter for treating a fluid in a piping, in particular of a water supply network, according to the preamble of claim 1. Furthermore, the present invention relates to a method of operation of said filter.

The present invention relates, in particular, to piping of heating and/or cooling systems, particularly for household and/or industrial use.

### 2. The Relevant Technology

In hydronic heating and/or cooling systems, it has become increasingly common to take all possible actions aimed at keeping the heat-transfer fluid as clean as possible (which is normally water, possibly with the addition of glycol or similar substances) and free from impurities that, especially in old systems, usually have a very high concentration of ferrous particles released from system components, particularly from pipes (typically made of iron) and radiators.

Such impurities are circulated by a pump included in the system; therefore, they tend to impair the proper and efficient operation of control elements (e.g., valve components) and also of any heat exchangers included in the generators (e.g., boilers, refrigerators, heat pumps, and so on).

If such impurities are not removed, in the long run they can reduce the efficiency of the system and cause damage to its components, e.g., said control elements, exchangers and generators.

Moreover, such impurities may lead to perforation of the pipes due to corrosion; in fact, the accumulated impurities, in contact with the oxygen that is present in water, will tend to oxidize those parts of the system where they deposit and may cause corrosion of such parts, resulting in a perforated pipe.

For this reason, various techniques and methods exist in the art for removing impurities from the fluid circulating in the piping of a water supply network, in particular a heating and/or cooling system.

A first method requires the use of chemical additives that neutralize said impurities contained in the fluid; however, this technique has some significant drawbacks, in that the presence of such additives must be constantly monitored and the system has to be shut down in order to add more additive when its concentration is insufficient and/or lower than required for effectively removing the impurities.

Another method uses at least one filter associated with a pipe of the water supply network, in particular of a heating and/or cooling system, said filter trapping the impurities contained in the system and being typically associated with a pipe of the return circuit of the system, for protecting the power generator (whether a heating power generator, e.g., a boiler, or a cooling power generator). In particular, according to this other technology, it is known to use a filtering element comprising at least one magnetic element adapted to intercept and trap the ferrous impurities that are present in the fluid to be treated.

It is clear that the filters normally employed for heating and cooling system protection must be periodically maintained, in particular for the purpose of removing the residues of impurities that have accumulated after the heat-transfer fluid has flowed through it many times.

However, the filters known in the art suffer from a few drawbacks, in that they are so designed as to not allow one to know when said maintenance is required for removing the impurities accumulated on said at least one magnetic element of the filtering element, which impair the proper operation of the latter.

Another drawback of the filters known in the art is that they are designed in such a way that they cannot be installed in the limited space normally available in modern heating and cooling systems for a filter specifically designed for separating and removing ferrous parts from the heat-transfer fluid; it must be pointed out that this problem is particularly felt in apartments and houses where the power generator (boiler) is placed in suitable wall units that normally do not leave sufficient room for positioning a filter for separating and removing ferrous parts from the heat-transfer fluid.

A further drawback lies in the fact that the filters known in the art are not versatile and do not allow an installer to easily use the same filter in association with different types of power generators and different installation configurations.

### SUMMARY OF THE INVENTION

In this frame, it is the main object of the present invention to provide a filter for treating a fluid in a piping, in particular of a water supply system, which is so designed as to overcome the drawbacks of the prior art.

In particular, it is one object of the present invention to provide a filter for treating a fluid in a piping, in particular of a water supply network, and a method of operation thereof, which can provide an indication about the quantity of impurities that have accumulated on the filtering element, in particular for the purpose of knowing when maintenance is required in order to remove said impurities.

Therefore, it is an object of the present invention to provide a filter and a method of operation thereof which are so conceived as to ensure optimal operation of the filter and to provide the user with indications about the accumulation of impurities on its filtering element.

It is another object of the present invention to provide a filter for treating a fluid in a piping, in particular of a water supply network, which is so conceived that it can be optimally installed in the limited space available in modern heating and cooling systems.

It is a further object of the present invention to provide a filter for treating a fluid in a piping, in particular of a water supply network, which is versatile and which allows an installer to easily use the same filter with different types of power generators and in different installation configurations.

It is yet another object of the present invention to provide a filter for treating a fluid in a piping, in particular of a water supply network of a heating and/or cooling system, which is so designed that it can be easily subjected to maintenance work for removing the residues of the impurities accumulated thereon after the heat-transfer fluid has flowed through it many times.

Said objects are achieved by the present invention through a filter for treating a fluid in a piping, in particular of a water supply network, and a method of operation thereof, incorporating the features set out in the appended claims, which are an integral part of the present description.

### BRIEF DESCRIPTION OF THE DRAWINGS

Further objects, features and advantages of the present invention will become apparent from the following detailed description and from the annexed drawings, which are supplied by way of non-limiting explanatory example, wherein:

FIG. 1 is a sectional view of the filter for treating a fluid in a piping, in particular of a water supply network, according to the present invention;

FIG. 2 is a partially exploded sectional view of the filter according to the present invention;

FIGS. 3a, 3b and 3c show a perspective view of the filter according to the present invention in first, second and third working conditions, respectively.

### DETAILED DESCRIPTION OF THE PREFERRED EMBODIMENTS

In the annexed drawings, reference numeral 1 designates as a whole a filter for treating a fluid in a piping (not shown in the annexed drawings), in particular of a water supply network, according to the present invention. In particular, said water supply network consists of a heating and/or cooling system.

In particular, said filter 1 comprises:
a main body 10 comprising at least one internal chamber 10A;
a filtering element (designated as a whole by reference numeral 20) for treating the fluid, said filtering element 20 comprising at least one magnetic element 21 housed at least partially in said chamber 10A and adapted to intercept and trap the ferrous impurities that are present in the fluid to be treated.

In accordance with the present invention, the filter 1 comprises at least one magnetic detector 30 associated with said main body 10 for detecting the magnetic field generated by said at least one magnetic element 21.

In addition, the filter 1 according to the present invention comprises a control unit 40 associated with said at least one magnetic detector 30, said control unit 40 being adapted to process the magnetic field information received from said at least one magnetic detector 30 and to provide an indication about the quantity of impurities that have accumulated on the filtering element 20.

In a first embodiment, said at least one magnetic detector 30 may consist of at least one magnetic switch adapted to detect the state of the magnetic field generated by said at least one magnetic element 21; alternatively, in accordance with a second embodiment, said at least one magnetic detector 30 may consist of at least one magnetic sensor adapted to measure the magnetic field generated by said at least one magnetic element 21.

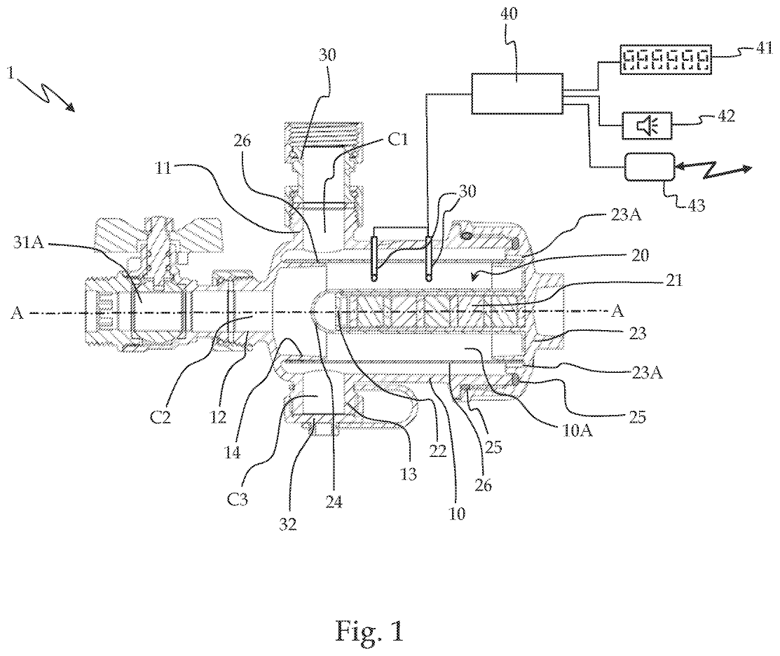

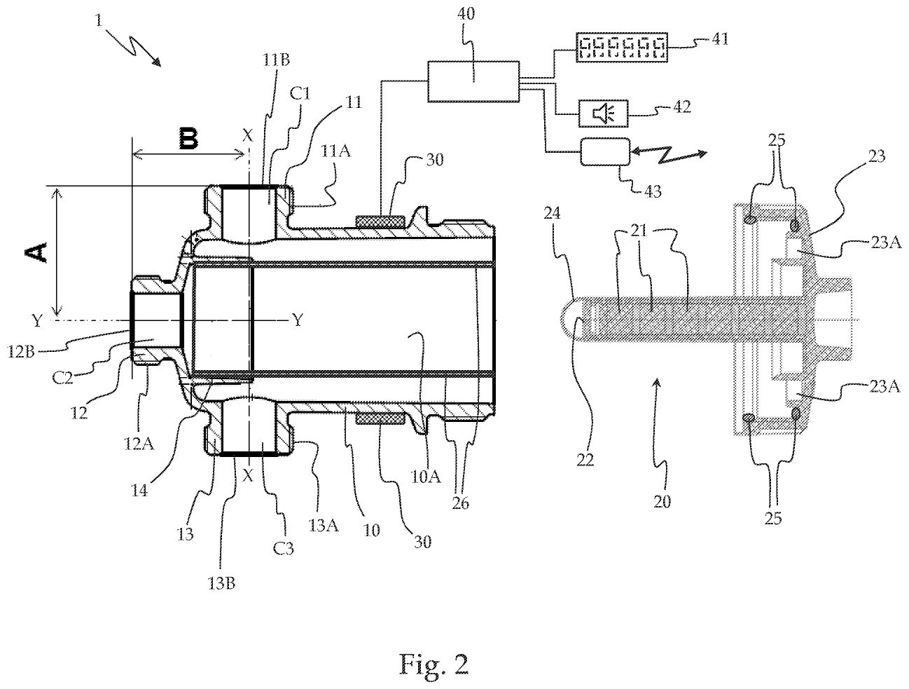

Furthermore, said at least one magnetic detector 30 may be at least partially inserted in the chamber 10A, as shown in the embodiment example of FIG. 1; as an alternative, said at least one magnetic detector 30 may be associated with an outer portion or surface of the main body 10, as in the embodiment example shown in FIG. 2, wherein said at least one magnetic detector 30 is so positioned as to surround and substantially embrace the outer surface of the main body 10; in particular, said at least one magnetic detector 30 may have a substantially arched or annular shape.

FIGS. 1 and 2 also show that the filter 1 preferably comprises a first signalling device 41 of the video type and/or a second signalling device 42 of the audio type associated with said control unit 40, wherein at least one of said signalling devices 41, 42 is activated by the control unit 40 in order to provide a user with an indication about the quantity of impurities that have accumulated on the filtering element 20.

In particular, said indication may be provided as an alarm signal (of the visual type, when issued by the first signalling device 41, and/or of the audible type, when issued by the second signalling device 42) when the quantity of impurities that have accumulated on the filtering element 20 is such as to require maintenance of the filter 1 in order to remove the impurities.

In addition, the filter 1 according to the present invention preferably comprises transmission/reception means 43 associated with said control unit 40 and adapted to:
send the indication, processed by said control unit 40, about the quantity of impurities that have accumulated on the filtering element 20 to a remote station (not shown in the drawings), and/or
respond at any time to an interrogation from said remote station to provide the indication processed by the control unit 40, and/or
receive instructions from said remote station.

Said remote station, which may be an integral part of a power generator with which the filter 1 is associated, or which may consist of a portable terminal, can thus acquire the indications processed by the control unit 40 pertaining to the clogging condition of the filter 1 and hence decide what actions need to be taken, which may include a notification integrated with an external application (via messaging, e-mail, etc.), sending specific instructions to the transmission/reception means 43 and to the control unit 40 (e.g., instructions for stopping the power generator before the filter 1 becomes totally clogged), and so on.

Preferably, the control unit 40 is associated with power supply means (not shown in the annexed drawings), which may consist, for example, of a battery; furthermore, said at least one magnetic detector 30, the control unit 40, the first signalling device 41 of the video type, the second signalling device 42 of the audio type and the transmission/reception means 43 are preferably mounted on a structure (not shown in the annexed drawings) that may be formed directly on the outer portion or surface of the main body 10 or associated with said outer portion or surface of the main body 10.

The peculiar characteristics of said at least one magnetic detector 30 and of the control unit 40 according to the present invention allow realizing said filter 1 in such a way as to ensure its optimal operation, since the magnetic detector 30 and the control unit 40 continuously provide a user with accurate indications about the accumulation of impurities on the filtering element 20. It is therefore clear that the user, thanks to said indications, is put in a condition to understand when maintenance work is needed for removing the impurities from the filtering element 20 and to readily take action in order to restore the filter 1 to its optimal operating condition.

In a preferred embodiment, the filter 1 comprises a plurality of magnetic detectors 30 associated with said main body 10, in particular said magnetic detectors 30 being positioned at different distances from said at least one magnetic element 21 of the filtering element 20. This provision ensures a more accurate and reliable indication about the quantity of impurities that have accumulated on the filtering element 20. In fact, the arrangement of said magnetic detectors 30 at different distances from said at least one magnetic element 21 allows one to understand when the geometric zone concerned by the flux lines generated by the magnetic element 21 tends to get filled with ferrous impurities and, also due to a suitable management logic included in the control unit 40, allows providing the user with an appropriate signal. For example, said signal may be provided by means of a luminous sequence generated by the first signalling device 41 of the video type (e.g., by using light sources with colours ranging from green—to indicate the absence of impurities or a low concentration thereof—to red—to indicate an excessive concentration of impurities on the filtering element 20—possibly with a plurality of intermediate colours) and/or by means of an audible signal emitted by the second signalling device 42 of the audio type (e.g., said audible signal may be an intermittent signal and/or a signal the intensity of which increases with the concentration of impurities on the filtering element 20). In addition, said signalling may be provided by sending the indication, processed by said control unit 40, about the quantity of impurities that have accumulated on the filtering element to a remote station by means of said transmission/reception means 43 and/or by responding to an interrogation from a portable terminal or from said remote station; as a result of such signalling, the remote station can acquire the indications processed by the control unit 40, concerning the clogging condition of the filter 1, and can decide accordingly what actions to take (notification integrated with an external application, sending instructions to the transmission/reception means 43 and to the control unit 40 to stop the power generator before the filter 1 becomes totally clogged, and so on).

It should be noted that, for simplicity, FIGS. 1 and 2 respectively show just two magnetic detectors 30 (see FIG. 1) and just one magnetic detector 30 (see FIG. 2); it is however clear that the number of magnetic detectors 30 associated with the main body 10 and/or with the chamber 10A may be greater.

It should also be noted that the principle according to which it is possible to know the concentration level of impurities on the filtering element 20 is based on the fact that the flux lines generated by the magnetic element 21 tend to go through the accumulated ferrous impurities and, when said accumulated ferrous impurities reach the magnetic detector 30 (especially when the latter consists of a magnetic switch), the circuit to which the detector is connected will be closed, thus making it also possible to discriminate between different degrees of clogging.

In accordance with the present invention, the filtering element 20 comprises a plurality of magnetic elements 21, in particular associated with one another in such a way as to form a substantially rod-like shape.

In particular, said plurality of magnetic elements 21 is so arranged as to develop parallel to a longitudinal axis A-A of the filter 1 (said longitudinal axis A-A being indicated in FIG. 1 by means of a dashed-dotted line).

Preferably, the filtering element 20 comprises also the following elements:
a magnet cartridge 22 adapted to house said at least one magnetic element 21,
a plug 23 adapted to be secured to the main body 10;
a sheath 24 adapted to house the magnet cartridge 22 and to be coupled to the plug 23.

In particular, the magnet cartridge 22 and the sheath 24 extend in such a way as to allow said at least one magnetic element 21 to be positioned within the chamber 10A of the main body 10.

Moreover, said sheath 24 is removable, since it can be separated from said magnet cartridge 22 and/or from at least one magnetic element 21 and from the plug 23; also, it is preferably made of plastic material.

The fact that the sheath 24 can be removed facilitates the cleaning of the ferrous residues captured by said at least one magnetic element 21, which cleaning would otherwise be difficult to carry out because of the considerable intensity of the magnetic field generated by said at least one magnetic element 21.

Preferably, the filter 1 according to the present invention comprises at least one sealing element 25 (e.g., a gasket) positioned between the plug 23 and the main body 10 to prevent any leakage of fluid from the filter 1.

In particular, the plug 23 is screwed to the main body 10 with the interposition of a pair of sealing elements 25.

The particular provisions of the filtering element 20 according to the present invention allow providing a filter 1 for treating a fluid, in particular in a water supply network, which is so designed as to allow for optimal removal of the impurities contained in a fluid flowing in said water supply network, while also facilitating the maintenance required for removing the residues of the impurities accumulated after the heat-transfer fluid has flowed through it many times.

It must be pointed out that the filter 1 according to the present invention may also comprise a second filtering element 26, in particular of the mesh type, positioned in the chamber 10A; in particular, said second filtering element 26 allows the fluid to be subjected to an additional filtering action in order to trap the non-ferromagnetic impurities that might escape from the action of the magnetic field exerted by the magnetic filtering element 20.

In a preferred embodiment, said second filtering element 26 has a substantially tubular shape; in particular, the second filtering element 26 is so positioned as to embrace or enclose the assembly consisting of the filtering element 20, the magnet cartridge 22 and the sheath 24.

Advantageously, the main body 10 comprises a wall 14 that extends parallel to the longitudinal axis A-A of the filter 1, so as to mate with a tract of the second filtering element 26 and allow it to be correctly positioned within the chamber 10A.

In particular, the wall 14 is also substantially tubular in shape and may have:
a slightly smaller section (as shown in FIG. 1) than that of the second filtering element 26, so that said wall 14 can be inserted into an initial tract of the second filtering element 26, or
a slightly greater section (as shown in FIG. 2) than that of the second filtering element 26, so that said wall 14 can be slipped over the initial tract of the second filtering element 26.

Moreover, the plug 23 is preferably so shaped as to comprise a recess 23A (in particular having a substantially circular shape in a front view, i.e., when viewed in a direction parallel to the axis A-A of the filter 1), which is adapted to house a terminal portion of the second filtering element 26 and allow it to be correctly positioned within the chamber 10A, in particular in co-operation with the wall 14.

In accordance with a preferred embodiment of the filter 1 according to the present invention, the main body 10 comprises a first mouth 11, a second mouth 12 and a third mouth 13, which have substantially the same shape.

As can be seen in FIGS. 1 and 2, said first mouth 11, second mouth 12 and third mouth 13 comprise, respectively, a first duct C1, a second duct C2 and a third duct C3, which allow the fluid to enter and/or exit the chamber 10A.

In particular, a first side 11A of the first mouth 11, a second side 12A of the second mouth 12 and a third side 13A of the third mouth 13 are made in substantially the same manner in terms of dimensions and shape; it should be noted that, in the present description, the term “side” refers to that surface of the mouths 11, 12, 13 which is opposite to that which faces the first duct C1, the second duct C2 and the third duct C3, respectively.

Moreover, the first mouth 11, the second mouth 12 and the third mouth 13 comprise similar connection means; for example, said connection means may consist of identical threads on the sides 11A, 12A, 13A of said first mouth 11, second mouth 12 and third mouth 13.

In a preferred embodiment, the first mouth 11, the second mouth 12 and the third mouth 13 are positioned on the main body 10 in such a way as to lie in substantially the same longitudinal plane, said longitudinal plane being parallel to a longitudinal axis A-A (visible in FIG. 1) of the filter 1; this feature of the mouths 11, 12, 13 can be observed in FIGS. 1 and 2, which show a longitudinal section of the filter 1, i.e. according to a longitudinal plane parallel to said longitudinal axis A-A of the filter 1.

In addition, the first mouth 11 and the third mouth 13 are positioned on the main body 10 on opposite sides relative to the chamber 10A and in such a way as to have first longitudinal axes X substantially coinciding with each other (note that said first longitudinal axes X are substantially perpendicular to said longitudinal axis A-A of the filter 1); therefore, in the sectional view of FIG. 2, the first longitudinal axes X of the first mouth 11 and third mouth 13 are obviously represented as one axis X.

In this embodiment, the second mouth 12 is positioned on the main body 10 in such a way as to have a second longitudinal axis Y substantially perpendicular to the first longitudinal axes X of the first mouth 11 and third mouth 13; therefore, the second longitudinal axis Y is substantially parallel to (and may also coincide with) said longitudinal axis A-A of the filter 1.

In a preferred embodiment (shown in FIG. 2), the first mouth 11, the second mouth 12 and the third mouth 13 are located on the main body 10 in such a way that the ratio between:
a first distance A, measured between the second axis Y and a straight line passing through a first inlet section 11B of the first mouth 11, and
a second distance B, measured between the first axis X and a straight line passing through a second inlet section 12B of the second mouth 12,
lies within a range of values from a minimum value of 0.8 to a maximum value of 1.2, in particular said first distance A and second distance B being shorter than 50 mm.

It is clear that said distance A may also be a distance between the second axis Y and a straight line passing through a third inlet section 13B of the third mouth 13. Furthermore, said distance B may also be a distance between the first axis X of the third mouth 13 and a straight line passing through said second inlet section 12B of the second mouth 12, since the first mouth 11 and the third mouth 13 have substantially coinciding first longitudinal axes X.

Preferably, the main body 10 has a substantially cylindrical shape; in this embodiment, the first mouth 11 and the third mouth 13 are positioned on the side surface of the main body 10, whereas the second mouth 12 is positioned at one end (or base) of the substantially cylindrical main body 10.

The peculiar features of the filter 1 according to the present invention make said filter 1 suitable for optimal installation in the limited space available in modern heating and cooling systems.

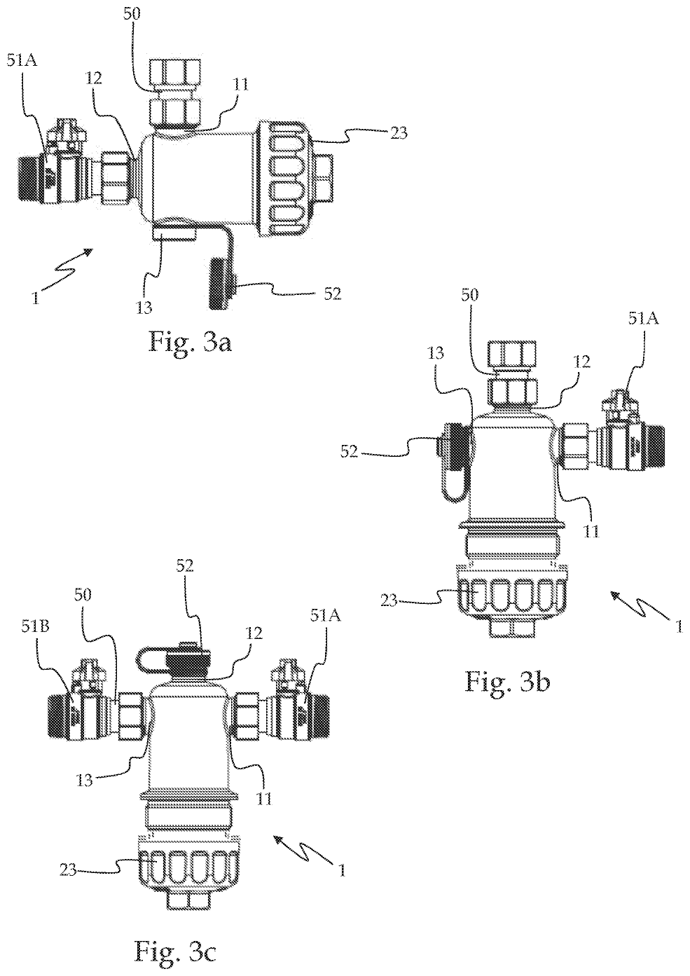

In fact, as can be observed in FIGS. 3a to 3c, the filter 1 according to the present invention can be used without distinction:
in a first configuration (shown in FIGS. 1 and 3a), wherein the first mouth 11 is associated with a duct 50 (in particular for delivering the fluid towards a power generator, not shown), the second mouth 12 is associated with a first on-off valve 51A that allows stopping the flow of fluid towards the filter 1, the third mouth 13 is associated with a closing element 52 (which in FIG. 3a is shown in a condition in which it leaves the third mouth 13 open, i.e. a condition in which the fluid can be drained from a power generator and/or system through the third mouth 13);
in a second configuration (shown in FIG. 3b), wherein the first mouth 11 is associated with the first on-off valve 51A, which allows stopping the flow of fluid towards the filter 1, the second mouth 12 is associated with the duct 50 for delivering the fluid towards a power generator, the third mouth 13 is associated with the closing element 52;
in a third configuration (shown in FIG. 3c), wherein the first mouth 11 is associated with the first on-off valve 51A, which allows stopping the flow of fluid towards the filter 1, the second mouth 12 is associated with the closing element 52, the third mouth 13 is associated with the duct 50 for delivering the fluid towards a power generator; said duct 50 and/or said third mouth 13 may possibly be associated with a second on-off valve 51B.

It should be noted that in the first configuration (FIG. 3a) the filter 1 and the filtering element 20 are positioned substantially horizontally, whereas in the second and third configurations (FIGS. 3b and 3c) they are directed substantially downwards.

Therefore, the provisions of the present invention allow providing a filter 1 that turns out to be very versatile, in that such provisions will allow an installer to easily and readily use the filter 1 with different types of power generators and in different installation configurations.

As previously described, the main body 10 has a substantially cylindrical shape; in this embodiment, the plug 23 of the filtering element 20 is secured at one end of the main body 10, opposite to that with which the second mouth 12 is associated.

In FIGS. 1 and 2 it can also be observed that the second filtering element 26 is so arranged as to surround the inlet portion of the second duct C2 in the chamber 10A and to extend parallel to the longitudinal axis A-A (visible in FIG. 1) of the filter 1 until it comes in contact with the plug 23.

Advantageously, the wall 14 is so positioned in the chamber 10A as to surround the inlet portion of the second duct C2 in said chamber 10A.

The following will briefly describe a method of operation of a filter 1 for treating a fluid in a piping, in particular of a water supply network, said filter 1 comprising:
a main body 10 comprising at least one internal chamber 10A;
a filtering element 20 for treating the fluid, said filtering element 20 comprising at least one magnetic element 21 housed at least partially in said chamber 10A and adapted to intercept and trap the ferrous impurities that are present in the fluid to be treated.

According to the present invention, said method comprises the following steps:
a) detecting the magnetic field generated by said at least one magnetic element 21 through at least one magnetic detector 30 associated with said main body 10;
b) processing the information about the detected magnetic field, received from said at least one magnetic detector 30, by means of a control unit 40 associated with said at least one magnetic detector 30;
c) providing an indication about the quantity of impurities that have accumulated on the filtering element 20 by means of said control unit 40.

In accordance with the present invention, said step c) can be carried out through a step c1), wherein said control unit 40 activates (whether directly or indirectly) a first signalling device 41 of the video type and/or a second signalling device 42 of the audio type in order to provide a user with said indication about the quantity of impurities that have accumulated on the filtering element 20.

In particular, said indication may be provided as an alarm signal (of the visual type, when issued by the first signalling device 41, and/or of the audible type, when issued by the second signalling device 42) when the quantity of impurities that have accumulated on the filtering element 20 is such as to require maintenance of the filter 1 in order to remove the impurities.

Furthermore, said step c) can be carried out through a step c2), wherein said control unit 40 activates (whether directly or indirectly) transmission/reception means 43 in order to:
send the indication, processed by said control unit 40, about the quantity of impurities that have accumulated on the filtering element 20 to a remote station, and/or
respond at any time to an interrogation from said remote station to provide said indication processed by the control unit 40, and/or
receive instructions from said remote station.

Preferably, said step a) of measuring the magnetic field is carried out through a plurality of magnetic detectors 30 associated with said main body 10; in particular, said magnetic detectors 30 being positioned at different distances from said at least one magnetic element 21 of the filtering element 20.

The features of the filter 1 according to the present invention, as well as the advantages thereof, are apparent from the above description.

In fact, the peculiar features of the filter 1 according to the present invention allow realizing said filter 1 in such a way as to ensure optimal operation thereof, since the magnetic detector 30 and the control unit 40 continuously provide the user with accurate indications about the accumulation of impurities on the filtering element 20. It is therefore apparent that the user, thanks to said indications, is put in a condition to know and understand when maintenance is necessary for removing the impurities from the filtering element 20 and to readily take action in order to restore the filter 1 to its optimal operating condition.

Moreover, by realizing the filter 1 in such a way that it comprises a plurality of magnetic detectors 30 associated with said chamber 10A, in particular said magnetic detectors 30 being positioned at different distances from said at least one magnetic element 21 of the filtering element 20, a more accurate and reliable indication can be obtained as concerns the quantity of impurities that have accumulated on the filtering element 20.

It should also be noted that the provisions of the present invention allow realizing said filter 1 in such a way that it can be optimally installed in the limited space available in modern heating and cooling systems.

Furthermore, the provisions of the present invention allow providing a filter 1 that turns out to be very versatile, in that such provisions will allow an installer to easily and readily use the filter 1 with different types of power generators and in different installation configurations.

The particular conformation of the filter 1 according to the present invention also facilitates the maintenance work required for removing the residues of the impurities that have accumulated after the heat-transfer fluid has flowed through it many times.

The filter 1 for treating a fluid in a piping, in particular of a water supply network, described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described filter and method of operation thereof, but may be subject to many modifications, improvements or replacements of equivalent parts and elements without departing from the inventive idea, as clearly specified in the following claims.

1. A filter for treating a fluid in a piping, in particular of a water supply network, said filter comprising:
a main body comprising at least one internal chamber;
a filtering element for treating the fluid, said filtering element comprising at least one magnetic element housed at least partially in said chamber and adapted to intercept and trap the ferrous impurities that are present in the fluid to be treated;
at least one magnetic detector associated with said main body for detecting the magnetic field generated by said at least one magnetic element;
a control unit associated with said at least one magnetic detector, said control unit being adapted to process the magnetic field information received from said at least one magnetic detector and to provide an indication about the quantity of impurities that have accumulated on the filtering element.

2. The filter according to claim 1, further comprising a first signalling device of the video type and/or a second signalling device of the audio type associated with said control unit, wherein at least one of said signalling devices is activated by the control unit in order to provide a user with an indication about the quantity of impurities that have accumulated on the filtering element.

3. The filter according to claim 1, further comprising transmission/reception means associated with said control unit and adapted to:
send the indication, processed by said control unit, about the quantity of impurities that have accumulated on the filtering element to a remote station, and/or
respond at any time to an interrogation from said remote station to provide said indication processed by the control unit, and/or
receive instructions from said remote station.

4. The filter according to claim 1, further comprising a plurality of magnetic detectors associated with said main body.

5. The filter according to claim 1, wherein said filtering element comprises a plurality of magnetic elements, in particular associated with one another in such a way as to form a substantially rod-like shape.

6. The filter according to claim 5, wherein said plurality of magnetic elements is so arranged as to develop parallel to a longitudinal axis of the filter.

7. The filter according to claim 5, wherein said filtering element comprises the following elements:
a magnet cartridge adapted to house said plurality of magnetic elements;
a plug adapted to be secured to the main body;
a sheath adapted to house the magnet cartridge and to be coupled to the plug.

8. The filter according to claim 1, wherein said main body comprises a first mouth, a second mouth and a third mouth having substantially the same shape, wherein said first mouth, second mouth and third mouth comprise, respectively, a first duct, a second duct and a third duct that allow the fluid to enter and/or exit the chamber.

9. The filter according to claim 8, wherein a first side of the first mouth, a second side of the second mouth and a third side of the third mouth are made in substantially the same manner in terms of dimensions and shape.

10. The filter according to claim 8, wherein the first mouth, the second mouth and the third mouth are located on the main body in such a way as to lie in substantially the same longitudinal plane, said longitudinal plane being parallel to a longitudinal axis of the filter.

11. The filter according to claim 10, wherein the first mouth, the second mouth and the third mouth are positioned on the main body in such a way that the ratio between:
a first distance, measured between the second axis and a straight line passing through a first inlet section of the first mouth, and
a second distance, measured between the first axis and a straight line passing through a second inlet section of the second mouth,
lies within a range of values from a minimum value of 0.8 to a maximum value of 1.2.

12. The filter according to claim 8, said main body has a substantially cylindrical shape, wherein the first mouth and the third mouth are located on the side surface of the main body, whereas the second mouth is located at one end of the substantially cylindrical main body.

13. A method of operation of a filter for treating a fluid in a piping, in particular of a water supply network, said filter comprising:
a main body comprising at least one internal chamber;
a filtering element for treating the fluid, said filtering element comprising at least one magnetic element housed at least partially in said chamber and adapted to intercept and trap the ferrous impurities that are present in the fluid to be treated,
said method comprises the following steps:
a) detecting the magnetic field generated by said at least one magnetic element through at least one magnetic detector associated with said main body;
b) processing the information about the detected magnetic field, received from said at least one magnetic detector, by means of a control unit associated with said at least one magnetic detector;
c) providing an indication about the quantity of impurities that have accumulated on the filtering element by means of said control unit.

14. The method according to claim 13, wherein step c) is carried out through a step c1), wherein said control unit activates a first signalling device of the video type and/or a second signalling device of the audio type in order to provide a user with said indication about the quantity of impurities that have accumulated on the filtering element.

15. The method according to claim 13, wherein step c) is carried out through a step c2), wherein said control unit activates transmission/reception means in order to:
send the indication, processed by said control unit, about the quantity of impurities that have accumulated on the filtering element to a remote station, and/or
respond at any time to an interrogation from said remote station to provide said indication processed by the control unit, and/or
receive instructions from said remote station.

16. The filter according to claim 4, wherein said magnetic detectors are positioned at different distances from said at least one magnetic element of the filtering element.

17. The filter according to claim 9, wherein said first mouth, second mouth and third mouth comprise similar connection means.

18. The filter according to claim 10, wherein the first mouth and the third mouth are positioned on the main body on opposite sides relative to the chamber and in such a way as to have first longitudinal axes substantially coinciding with each other, and the second mouth being positioned on the main body in such a way as to have a second longitudinal axis substantially perpendicular to the first longitudinal axes of the first mouth and third mouth.

19. The filter accordingly to claim 11, wherein the first distance and the second distance are shorter than 50 mm.
